(19) United States
(12) Patent Application Publication
(10) Pub. No.: US 2017/0329286 A1
(43) Pub. Date: Nov. 16, 2017

(54) LIGHT GUIDE PLATE, BACKLIGHT SOURCE AND SMART WATCH

(71) Applicant: BOE TECHNOLOGY GROUP CO., LTD., Beijing (CN)

(72) Inventor: Chunyan JI, Beijing (CN)

(21) Appl. No.: 15/522,755

(22) PCT Filed: Feb. 26, 2016
(86) PCT No.: PCT/CN2016/074637

§ 371 Date: Apr. 27, 2017

(30) Foreign Application Priority Data
Sep. 11, 2015 (CN) 201520705297.1

(51) Int. Cl. G04G 9/00; F21V 8/00; G02F 1/1335; H04W 4/00; G06F 1/16

(52) U.S. Cl. CPC G04G 9/0094; G02B 6/0068; G02B 6/0053; G02F 1/133603; G02B 6/0051; G02B 6/0055; G06F 1/163; H04W 4/008

(57) ABSTRACT

A light guide plate is disclosed which has an arc-shaped light incident surface. The arc-shaped light incident surface may be provided with a recess for accommodating a light-emitting element. Requirement for a display of a special (e.g., circular) shape may be met by the disclosed light guide plate. Also disclosed is a backlight source including the light guide plate and a smart watch including the backlight source.

### CROSS-REFERENCE TO RELATED APPLICATIONS

The present application is the U.S. national phase entry of PCT/CN2016/074637, with an international filing date of Feb. 26, 2016, which claims the benefit of Chinese Patent Application No. 201520705297.1, filed on Sep. 11, 2015, the entire disclosures of which are incorporated herein by reference.

### TECHNICAL FIELD

The present disclosure relates to the field of display technologies, and particularly to a light guide plate, a backlight source and a smart watch.

### BACKGROUND

With the development of mobile communication technologies, a multitude of traditional electronic products have been provided with functionalities relating to mobile communication. For example, watches, which could only be used to indicate time in the past, can nowadays be connected to the internet via a smart phone or a home network to display contents such as incoming calls, Twitter and news feeds, and weather forecasts. Such a watch may be referred to as a smart watch, which is primarily designed for a scenario where it is inconvenient for a consumer to use his/her smart phone, for example, when he/she is riding a bicycle or is carrying something in hand.

Consumer investigations indicate that the most welcome appearance for the smart watch is a circular appearance which is closest to that of the traditional watch. However, if a circular display is used, a complicated optical design may have been required for a state-of-art smart watch that is based on a liquid crystal display (LCD), and it may have been difficult to ensure the uniformity of the exiting light.

### SUMMARY

Embodiments of the present disclosure provide a light guide plate, which may address the issue that existing light guide plates cannot meet the requirement of an arc-shaped (e.g., circular) display. A backlight source employing the light guide plate is also provided as well as a smart watch employing the backlight source.

According to an aspect of the present disclosure, a light guide plate for guiding light emitted by a light-emitting element is provided comprising an arc-shaped light incident surface, a light exit surface and a surface opposite to the light exit surface.

In an implementation, the arc-shaped light incident surface is provided with a recess for accommodating the light-emitting element.

In an implementation, the light guide plate is cylinder-shaped such that the arc-shaped light incident surface is a cylindrical surface.

In an implementation, the light incident surface is provided with a plurality of recesses arranged around an axis of the cylindrical surface at an angular interval, each of the recesses arranged to accommodate one or more light-emitting elements.

In an implementation, the angular interval is in a range of 45° to 120°.

In an implementation, the surface opposite to the light exit surface is provided with a plurality of light guide dots.

In an implementation, the plurality of light guide dots are arranged such that the closer the light guide dots are to the light-emitting element, the sparser the light guide dots are.

In an implementation, the plurality of light guide dots are arranged such that the closer the light guide dots are to the light-emitting element, the smaller the light guide dots are.

According to another aspect of the present disclosure, a backlight source is provided comprising the light guide plate as described above and a plurality of light-emitting elements. The plurality of light-emitting elements are arranged along the arc-shaped light incident surface of the light guide plate.

In an implementation, each of the plurality of light-emitting elements is a light-emitting diode.

In an implementation, the light-emitting diode has a flexible substrate.

According to yet another aspect of the present disclosure, a smart watch is provided comprising the backlight source as described above.

The light guide plate according to embodiments of the present disclosure has the advantage that by the use of an arc-shaped light incident surface, a plurality of light-emitting elements are allowed to be arranged separately from each other along the arc-shaped light incident surface, leading to uniform exiting light. Hence, the requirement of an arc-shaped (e.g., circular) display may be met.

### BRIEF DESCRIPTION OF THE DRAWINGS

The accompanying drawings are introduced below in brief for a clear illustration of the embodiments of the present disclosure.

FIG. 1 is a top view of a structure of a light guide plate according to an embodiment of the present disclosure;

FIG. 2 is a schematic diagram of a distribution of light guide dots on a bottom side of a light guide plate according to an embodiment of the present disclosure;

FIG. 3 is a schematic diagram showing a variation in density of distribution of light guide dots on a bottom side of a light guide plate according to an embodiment of the present disclosure; and

FIG. 4 is a cross-sectional schematic diagram of a structure of a light guide plate according to an embodiment of the present disclosure.

### DETAILED DESCRIPTION

Embodiments of the present disclosure will be described clearly and fully with reference to the accompanying drawings. Apparently, the embodiments described are only a part and not all of the embodiments of the present disclosure. All other embodiments derived by those skilled in the art from the embodiments of the present disclosure without making any inventive effort fall within the scope of the present disclosure.

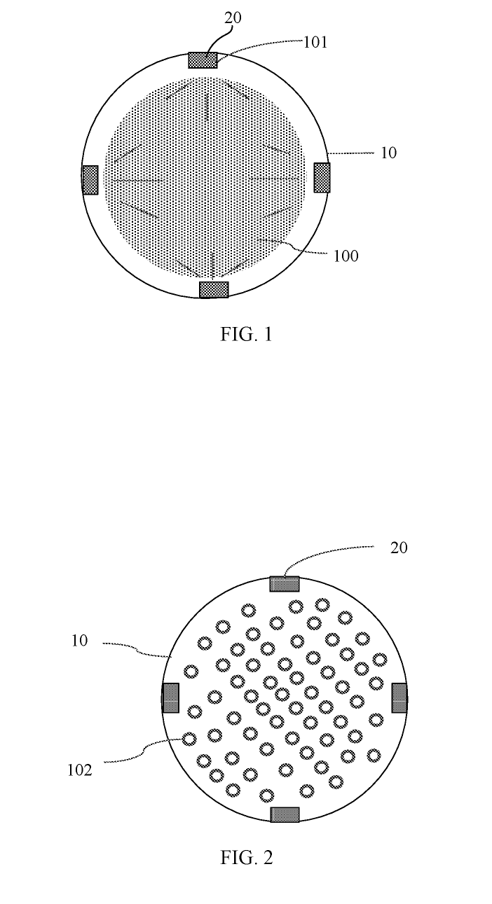

FIG. 1 is a top view of a structure of a light guide plate 10 according to an embodiment of the present disclosure. The light guide plate 10 has an arc-shaped light incident surface, a light exit surface 100 and a surface opposite to the light exit surface 100 (not shown). In the illustrated example, the periphery of the light guide plate 10 is a closed arc shape. It is to be noted that since the light guide plate 10 has a certain thickness, the term “arc” as used herein should be interpreted as “curved”.

The arc-shaped light incident surface may be provided with a recess 101 for accommodating a light-emitting element 20. In the case of a plurality of light-emitting elements 20, a plurality of recesses may be provided. By placing the light-emitting elements 20 in the recess 101, the light-emitting elements 20 may be fixed and a distributed arrangement of the light-emitting elements 20 may be achieved. In addition, the efficiency of the incident light may be ensured without increasing the installation space.

The light guide plate 10 as described above may be used in a display having an arc-shaped side, for example, a circular or approximately circular display. The arc-shaped side surface of the light guide plate 10 serves as a light incident surface on which a plurality of light-emitting elements 20 may be distributed separately. This may address some issues of an existing light guide plate. The existing light guide plate typically employs a design where the light is incident from a single side, and hence cannot meet the requirement of a circular display.

For an application in which the circular display is used, the light guide plate 10 may be cylinder shaped such that the arc-shaped light incident surface is a cylindrical surface. The light incident surface may be provided with a plurality of recesses 101 arranged around an axis of the cylindrical surface at an angular interval. Each of the recesses 101 is arranged to accommodate one or more light-emitting elements 20.

In the example shown in FIG. 1, four recesses 101 are arranged on the side surface of the cylindrical light guide plate 10 at an angular interval of 90°. One recess 101 may accommodate at least one light-emitting element 20. In one example, the light-emitting element 20 is a light-emitting diode (LED). Further, the light-emitting diode may have a flexible substrate or a small size. The small size may mean that the light-emitting diode is sized such that the light-emitting diode is applicable to devices having a small screen, such as a smart watch.

More generally, the angular interval may be in a range of 45° to 120°. For an application of the smart watch, three to four LEDs may generally be sufficient. When three LEDs 20 are employed, the angular interval may be 120°. When four LEDs 20 are employed, the angular interval may be 90°. Since the divergence angle of the LED is up to above 120°, such an arrangement of LEDs may provide a uniform light emission region that is approximately circular.

In some embodiments, the light guide plate 10 may also comprise a flat light incident surface. At the flat light incident surface, the plurality of light-emitting elements 20 may be arranged in the same way as the prior art, or in a distributed manner. In some embodiments, the light guide plate 10 may also have other shapes such as an ellipse, a cardioid, or a horseshoe. In particular, the light guide plate 10 may even be of an N-gonal shape, where N may be an integer equal to or larger than 4. For example, the light guide plate is of an octagon shape. It is to be understood that when the “shape” of the light guide plate is referred to, it refers to the shape of the cross section of the light guide plate taken in a direction perpendicular to the thickness direction.

FIG. 2 is a schematic diagram of a distribution of light guide dots 102 on a bottom side of a light guide plate 10 according to an embodiment of the present disclosure. The plurality of light guide dots 102 may be printed to the bottom side of the light guide plate 10 using e.g. UV screen printing. When the light impinges on the individual light guide dots 102, the light reflected by the light guide dots 102 scatters in all directions and exits via the light exit surface of the light guide plate 10. By means of light guide dots 102 with various densities of distribution and various sizes, the light may exit from the light guide plate 10 uniformly.

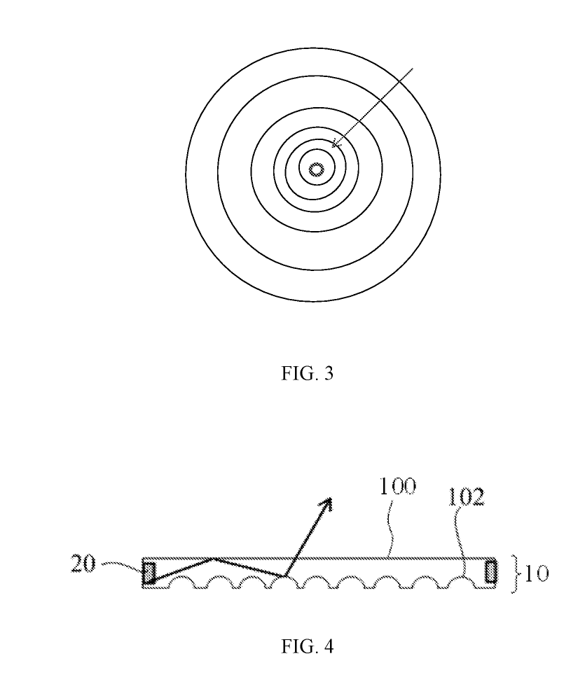

FIG. 3 is a schematic diagram showing a variation in density of distribution of light guide dots on a bottom side of a light guide plate according to an embodiment of the present disclosure. In the example shown in FIG. 3, the closer to the light-emitting element 20, the sparser the light guide dots 102 are. That is, the density of distribution of the light guide dots 102 changes from sparse to dense along the direction indicated by the arrow. Alternatively or additionally, the closer to the light-emitting element 20, the smaller the light guide dots 102 are. That is, the size of the light guide dot 102 closer to the light guide element 20 is smaller than the size of the light guide dot 102 farther away from the light-emitting element 20. In either case, uniform exiting light may be achieved without a need for a complicated sector design of the light guide dots 102. Furthermore, it should be understood that the bottom side of the light guide plate 10 refers to the surface of the light guide plate 10 that is opposite to the light exit surface.

FIG. 4 is a cross-sectional schematic diagram of a structure of a light guide plate 10 according to an embodiment of the present disclosure. The light guide plate 10 may be made of a transparent material (e.g., polymethyl methacrylate (PMMA) or polycarbonate (PC)). The light from the light-emitting element 20 is incident into the light guide plate 10 via the light incident surface (i.e., the side surface). The light exit surface 100 (i.e., the upper surface) is a smooth plane. The surface of the light guide plate 10 (i.e., the bottom side) that is opposite to the light exit surface is provided with the light guide dots 102. After entering the light guide plate 10 in different directions, a majority of the light emitted from the light-emitting element 20 is reflected by the light guide dots 102 and exits from the upper surface, whereas a small part of the light exits from the bottom side. The light exiting from the bottom side may be reflected by a reflection sheet (not shown) back into the light guide plate 10 and then is reused.

According to another aspect of the present disclosure, a backlight source is provided which comprises the light guide plate 10 as described above and a plurality of light-emitting elements 20. The plurality of light-emitting elements 20 may be arranged along the arc-shaped light incident surface of the light guide plate 10. As is known, the backlight source may further comprise a back plate, a rubber frame, a reflection sheet, a bright enhancement film/sheet, a diffusion film/sheet, and so on, description of which is omitted here for simplicity. The backlight source can meet the requirement of a display having an arc-shaped side, for example, a circular, approximately circular or other similarly shaped display. By means of such a backlight source, backlight illumination of a display having a special shape can be achieved with a simplified optical design and improved uniformity and efficiency. According to yet another aspect of the present disclosure, a smart watch is provided which comprises the backlight source as described above. By employing a backlight source applicable to a circular or approximately circular (e.g., N-gonal) display, such a smart watch may have a better display effect.

The foregoing are only specific embodiments of the present disclosure, and the present disclosure is not so limited. Variations and alternatives that are easily occurred to those skilled in the art should be encompassed in the scope of the present disclosure. Therefore, the scope of the present disclosure should be defined by the claims.

### LISTING OF REFERENCE NUMERALS

10—light guide plate, 100—light exit surface, 101—recess, 102—light guide dot, 20—light-emitting element.

1. A light guide plate for guiding light emitted by a light-emitting element, comprising an arc-shaped light incident surface, a light exit surface and a surface opposite to the light exit surface.

2. The light guide plate of claim 1, wherein the arc-shaped light incident surface is provided with a recess for accommodating the light-emitting element.

3. The light guide plate of claim 1, wherein the light guide plate is cylinder-shaped such that the arc-shaped light incident surface is a cylindrical surface.

4. The light guide plate of claim 3, wherein the light incident surface is provided with a plurality of recesses arranged around an axis of the cylindrical surface at an angular interval, each of the recesses arranged to accommodate one or more light-emitting elements.

5. The light guide plate of claim 4, wherein the angular interval is in a range of 45° to 120°.

6. The light guide plate of claim 1, wherein the surface opposite to the light exit surface is provided with a plurality of light guide dots.

7. The light guide plate of claim 6, wherein the plurality of light guide dots are arranged such that the closer the light guide dots are to the light-emitting element, the sparser the light guide dots are.

8. The light guide plate of claim 6, wherein the plurality of light guide dots are arranged such that the closer the light guide dots are to the light-emitting element, the smaller the light guide dots are.

9. A backlight source comprising:
the light guide plate as recited in claim 1; and
a plurality of light-emitting elements,
wherein the plurality of light-emitting elements are arranged along the arc-shaped light incident surface of the light guide plate.

10. The backlight source of claim 9, wherein each of the plurality of light-emitting elements is a light-emitting diode.

11. The backlight source of claim 10, wherein the light-emitting diode has a flexible substrate.

12. A smart watch comprising the backlight source as recited in claim 9.

13. A backlight source comprising:
the light guide plate as recited in claim 2; and
a plurality of light-emitting elements,
wherein the plurality of light-emitting elements are arranged along the arc-shaped light incident surface of the light guide plate.

14. A backlight source comprising:
the light guide plate as recited in claim 3; and
a plurality of light-emitting elements,
wherein the plurality of light-emitting elements are arranged along the arc-shaped light incident surface of the light guide plate.

15. A backlight source comprising:
the light guide plate as recited in claim 4; and
a plurality of light-emitting elements,
wherein the plurality of light-emitting elements are arranged along the arc-shaped light incident surface of the light guide plate.

16. A backlight source comprising:
the light guide plate as recited in claim 5; and
a plurality of light-emitting elements,
wherein the plurality of light-emitting elements are arranged along the arc-shaped light incident surface of the light guide plate.

17. A backlight source comprising:
the light guide plate as recited in claim 6; and
a plurality of light-emitting elements,
wherein the plurality of light-emitting elements are arranged along the arc-shaped light incident surface of the light guide plate.

18. A backlight source comprising:
the light guide plate as recited in claim 7; and
a plurality of light-emitting elements,
wherein the plurality of light-emitting elements are arranged along the arc-shaped light incident surface of the light guide plate.

19. A backlight source comprising:
the light guide plate as recited in claim 8; and
a plurality of light-emitting elements,
wherein the plurality of light-emitting elements are arranged along the arc-shaped light incident surface of the light guide plate.

20. A smart watch comprising the backlight source as recited in claim 10.
